(19) United States
(12) Patent Application Publication
(10) Pub. No.: US 2006/0205442 A1
(43) Pub. Date: Sep. 14, 2006

(54) Bi-directional amplifier with non-interruptible port

(76) Inventors: Neil Phillips, Dove Canyon, CA (US); Sou-Pen Su, Dunwoody, GA (US); Fu-Chin Shen, Keelung (TW)

Correspondence Address: STETINA BRUNDA GARRED & BRUCKER, 75 ENTERPRISE, SUITE 250, ALISO VIEJO, CA, 92656, US

(21) Appl. No.: 11/077,802

(22) Filed: Mar. 10, 2005

(51) Int. Cl. H04B 1/38; H04M 1/00

(52) U.S. Cl. 455/572

(57) ABSTRACT

A bi-directional RF signal amplifier can be provided with a non-interruptible communication path for maintaining communication between an input and output port in the event of power failure. The amplifier may receive RF signals from a service provider or any other appropriate signal source through an input port. In residential applications, the amplifier may receive a composite RF signal comprising information for telephone, cable television (CATV), Internet, VoIP, and/or data communication from a service provider. The amplifier may increase the signal to a more useful level of approximately 20 dBmV/carrier and pass the amplified signal to one or more devices in communication with the amplifier through various output ports. In the event of power failure, a signal may still be passed through the non-interruptible communication path between the service provider and the communication device.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention is directed to technology for providing non-interruptible communication.

2. Description of the Related Art

In recent years, the rise of the Internet and other online communication methods have rapidly transformed the manner in which electronic communications take place. Today, rather than relying on prior-generation switched telephone communication arrangements, many service providers are turning to modern Internet Protocol (IP) based communication networks. Such networks can provide flexibility in facilitating the transmission of voice, data, video, and other information at great speeds.

As a result, many consumers now have the option of conducting telephone conversations, receiving and sending information for interactive video, and communicating over the Internet—all through a single RF connection with the consumer's service provider. However, in order to support these various services, the RF signal received from the service provider (approximately 5 dBmV/channel) may require amplification by an RF amplifier in order to properly service the various communication ports maintained by a consumer.

Unfortunately, if power to the RF amplifier is interrupted, some or all of these services may become unavailable. Although such interruptions may be tolerated by consumers in relation to certain non-essential services, interruptions to other services may be unacceptable. For example, consumers relying on IP-based emergency communications (i.e. 911) can be left without such services during power interruptions.

In order to remedy this problem, some consumers may be inclined to acquire a dedicated switched telephone line to provide emergency services during power interruptions. Nevertheless, such an option can require the consumer to incur additional costs and fails to capitalize on the advantages offered by IP-based communication.

### BRIEF SUMMARY OF THE INVENTION

Various aspects of the present invention, roughly described, provide improved amplifier designs for facilitating communication between an input and output port in the event of power failure.

In one embodiment, a bi-directional RF signal amplifier can be provided comprising an RF input port, an RF output port, a power input for receiving electrical power, and circuitry for providing electrical power received by the power input to a plurality of amplifiers and a plurality of relays. A first relay in communication with the input port can be configured to switch from a powered position to an un-powered position when electrical power provided to the first relay is interrupted. A second relay in communication with the output port can be configured to switch from a powered position to an un-powered position when electrical power provided to the second relay is interrupted. The embodiment can include a first communication path for providing communication between the input port and the output port when electrical power is received at the power input. In such an embodiment, the first communication path can comprise the first relay switched in the powered position, the second relay switched in the powered position, a forward path amplifier in communication with the first relay and second relay, and an optional reverse path amplifier in communication with the first relay and second relay. The embodiment can further include a second communication path for providing communication between the input port and the output port when electrical power to the power input is interrupted. In such an embodiment, the second communication path can comprise the first relay switched in the un-powered position and the second relay switched in the un-powered position.

In another embodiment, a bi-directional RF signal amplifier can be provided comprising an RF input port, an RF output port, a power input for receiving electrical power, and circuitry for providing electrical power received by the power input to a plurality of amplifiers and a relay. The relay can be provided in communication with the input port and configured to switch from a powered position to an un-powered position when electrical power provided to the relay is interrupted. A directional coupler in communication with the output port can also be provided. The embodiment can include a first communication path for providing communication between the input port and the output port when electrical power is received at the power input. In such an embodiment, the first communication path can comprise the relay switched in the powered position, the directional coupler, a forward path amplifier in communication with the relay and the directional coupler, and an optional reverse path amplifier in communication with the relay and the directional coupler. The embodiment can further include a second communication path for providing communication between the input port and the output port when electrical power to the power input is interrupted. In such an embodiment, the second communication path can comprise the relay switched in the un-powered position and the directional coupler.

In a further embodiment, a bi-directional RF signal amplifier can be provided comprising an RF input port, a first RF output port, a second RF output port, a power input for receiving electrical power, and circuitry for providing electrical power received by the power input to a plurality of amplifiers. A directional coupler in communication with the input port can also be provided. The embodiment can include a first communication path for providing communication between the input port and the first output port when electrical power is received at the power input. In such an embodiment, the first communication path can comprise the directional coupler, a forward path amplifier in communication with the directional coupler, and an optional reverse path amplifier in communication with the directional coupler. The embodiment can further include a second communication path for providing communication between the input port and the second output port when electrical power to the power input is interrupted. In such an embodiment, the second communication path can comprise the directional coupler in communication with the second output port.

These as well as other embodiments contemplated by the present invention will be more fully set forth in the detailed description below and the figures submitted herewith.

### BRIEF DESCRIPTION OF THE DRAWINGS

FIG. 1 illustrates a block diagram of a bi-directional RF signal amplifier employing a directional coupler for facilitating a non-interruptible communication port, in accordance with an embodiment of the present invention.

FIG. 2 illustrates a block diagram of a bi-directional RF signal amplifier employing a non-latching relay and a directional coupler for facilitating a non-interruptible communication port, in accordance with an embodiment of the present invention.

FIGS. 3a and 3b illustrate block diagrams of bi-directional RF signal amplifiers employing a plurality of non-latching relays for facilitating a non-interruptible communication port, in accordance with an embodiment of the present invention.

FIGS. 4a and 4b illustrate a circuit schematic diagram of a bi-directional RF signal amplifier employing a directional coupler for facilitating a non-interruptible communication port, in accordance with an embodiment of the present invention.

FIGS. 5a and 5b illustrate a circuit schematic diagram of a bi-directional RF signal amplifier employing a non-latching relay and a directional coupler for facilitating a non-interruptible communication port, in accordance with an embodiment of the present invention.

FIGS. 6a and 6b illustrate a circuit schematic diagram of a bi-directional RF signal amplifier employing a plurality of non-latching relays for facilitating a non-interruptible communication port, in accordance with an embodiment of the present invention.

### DETAILED DESCRIPTION OF THE INVENTION

In accordance with various embodiments set forth in the present disclosure, a bi-directional RF signal amplifier can be provided with a non-interruptible communication port for maintaining communication in the event of power failure. In various embodiments, the amplifier may receive RF signals from a service provider or any other appropriate signal source through an input port.

For example, in residential applications, an amplifier in accordance with various embodiments of the present disclosure may receive a composite RF signal of approximately 5 dBmV/channel in the range of approximately 5-1000 MHz comprising information for telephone, cable television (CATV), Internet, VoIP, and/or data communication from a service provider. The amplifier may increase the signal to a more useful level of approximately 20 dBmV/channel and pass the amplified signal to one or more devices in communication with the amplifier through various output ports. Such devices may include, but need not be limited to: televisions, modems, telephones, computers, and/or other communication devices known in the art. In the event of power failure, an unamplified signal may still be passed through a communication path between the service provider and the communication device.

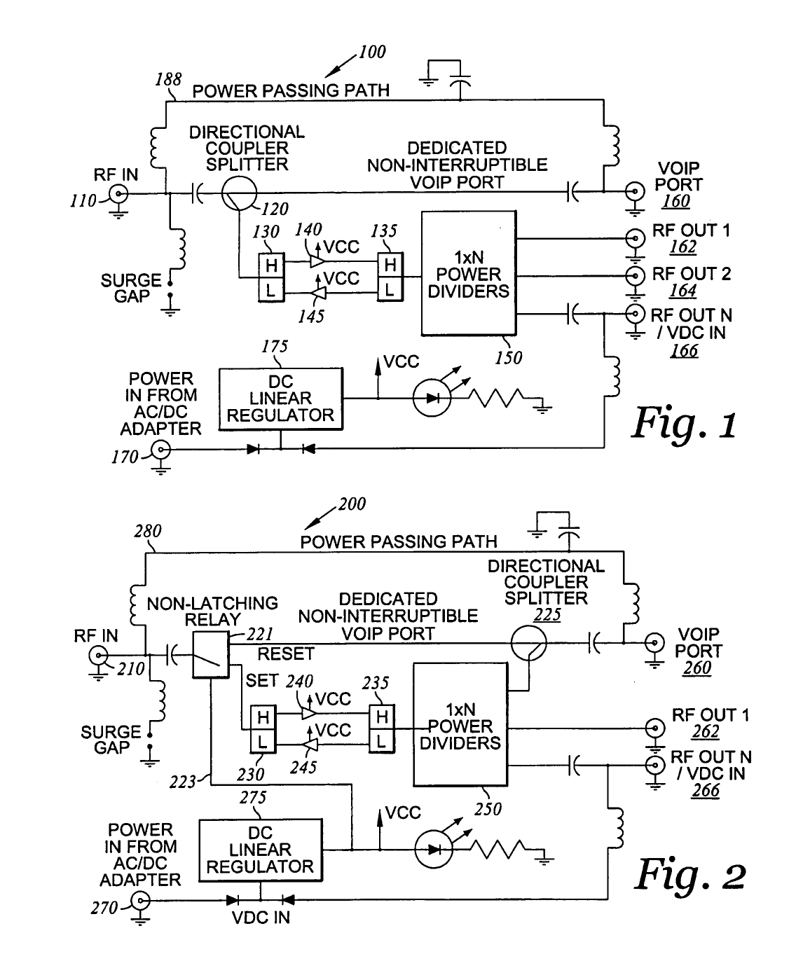

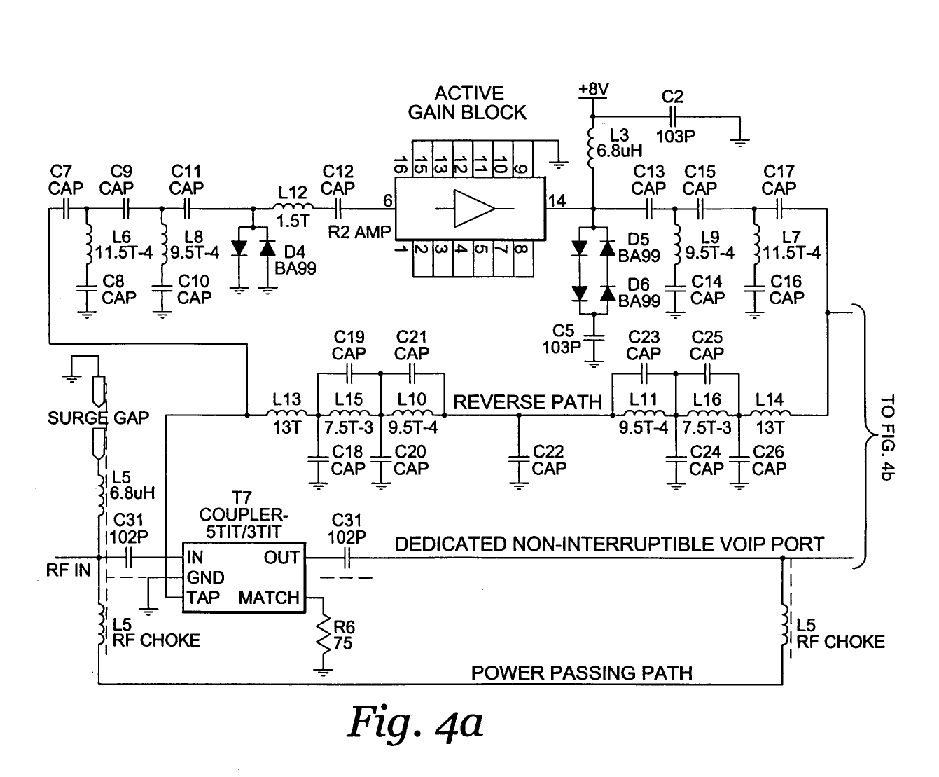

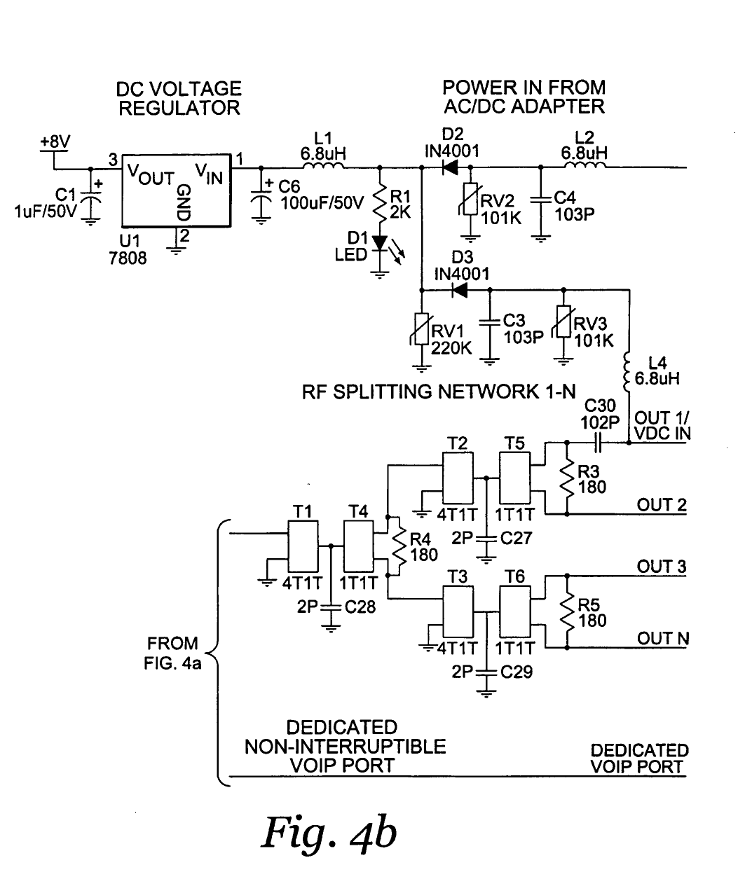

FIGS. 1, 2, and 3 illustrate several embodiments of such an amplifier. Schematic representations of the embodiments of FIGS. 1, 2, and 3a are set forth in FIGS. 4a/4b, 5a/5b, and 6a/6b, respectively.

FIG. 1 illustrates a block diagram of a bi-directional RF signal amplifier 100 employing a directional coupler for facilitating a non-interruptible communication port 160. As illustrated, amplifier 100 can support a plurality of bi-directional communication ports for sending and receiving RF signals to and from a variety of signal sources and destinations.

A bi-directional RF input port 110 can be provided for receiving RF signals from a service provider, or any other appropriate signal source. Input port 110 can also pass output signals in the reverse direction from the amplifier 100 through the port 110 to the service provider or other signal source.

A plurality of bi-directional output ports 160, 162, 164, and 166 can also be provided by amplifier 100 for passing RF signals from the amplifier 100 to one or more devices in communication with the output ports, and vice versa. It will be appreciated that any appropriate device that may advantageously send and/or receive an RF signal may be placed in communication with one or more of the various output ports. For example, it is contemplated that telephone, CATV, Internet, VoIP, and/or data communication devices may be placed in such communication where the amplifier 100 is installed in the residence of a subscriber to a service provider. However, it will further be appreciated that any desired combination of these and/or other devices may be used where appropriate, including devices other than those set forth in the labels of FIG. 1.

Signals received through input port 110 can be passed through a first communication path between input port 110 and output ports 162, 164, and/or 166. Specifically, the signals can be fed through a passive directional coupler 120 to a high/low diplexer 130 for separating the high frequency input signal from any low frequency output signal incident in the reverse direction. In various embodiments, diplexer 130 can filter the signals in a manner such that signals with frequencies greater than approximately 45-50 MHz are passed as high frequency input signals received from port 110, while signals with frequencies lower than such range are passed in the reverse direction as low frequency output signals received from ports 162, 164, or 166.

The high frequency input signals filtered by diplexer 130 can be amplified by individual amplifier 140, and passed to high/low diplexer 135 where they are combined with the output signals. The recombined signal can then be provided to power dividers 150, where it is distributed to any of ports 162, 164, and/or 166.

Turning now to the reverse signal flow through the first communication path of amplifier 100, signals received by the amplifier 100 from devices in communication with ports 162, 164, and/or 166 can be passed to power dividers 150 where they are combined into a composite output signal. The output signal can be fed through high/low diplexer 135 for separating the low frequency output signal from any high frequency input signal incident in the forward direction. As previously discussed in relation to diplexer 130, the diplexer 135 can filter the signals such that signals with frequencies greater than approximately 45-50 MHz are passed in the forward direction as high frequency signals received from port 110, while signals with frequencies lower than such range are passed in the reverse direction as low frequency signals received from ports 162, 164, and/or 166.

The low frequency output signals filtered by diplexer 135 can be amplified by individual amplifier 145, and passed to high/low diplexer 130 where they are combined with the input signals. In various embodiments, individual amplifier 145 can optionally be omitted from amplifier 100. The recombined signal can then be provided to coupler 120 where it is passed to port 110 for output to a service provider or other entity in communication with port 110.

As illustrated, amplifier 100 can further provide a power passing path 188, allowing power to be transmitted between ports 110 and 160.

During normal operation, the amplifier 100 can be powered from a power input port 170 and/or power that is reverse fed through RF Out N/VDC in port 166. In a typical installation at a subscriber's residence, it is contemplated that amplifier 100 may be powered by an AC/DC adapter receiving power provided by the residence (for example, 100-230 VAC, 50/60 Hz). As illustrated in FIG. 1, the power received from either power input can be provided to a voltage regulator 175 which supplies an operating voltage VCC to individual amplifiers 140 and/or 145.

In the event that power to voltage regulator 175 is interrupted, voltage regulator 175 will be unable to provide operating voltage VCC to individual amplifiers 140 and/or 145. As a result, individual amplifier 140 will not function to amplify the input signals received through port 110 for proper distribution to the various output ports 162, 164, and/or 166. Similarly, individual amplifier 145 also will not function to amplify the output signals received from ports 162, 164, and/or 166.

In response to this situation, amplifier 100 further provides a second communication path—a path between input port 110 and output port 160. In this regard, a dedicated non-interruptible port 160 can communicate with port 110 through coupler 120. Using this second communication path between ports 110 and 160 through coupler 120, signals can still be passed between a device in communication with port 160 and a service provider in communication with port 110. It will be appreciated that although the second communication path of amplifier 100 does not necessarily amplify the input or output signals, the path can nevertheless permit communication of at least one or more services, such as emergency 911 telephone service.

It will be appreciated that the use of the second communication path between ports 110 and 160 can provide a significant advantage in ensuring the availability of communication to at least one communication device in the event of power failure. A communication device in communication with port 160 (such as a VoIP compatible device, or other device) can further be provided with backup battery power to maintain the operation of the communication device. As discussed, a schematic representation of the amplifier 100 of FIG. 1 is set forth in FIGS. 4a and 4b.

FIG. 2 illustrates a block diagram of a bi-directional RF signal amplifier 200 employing a non-latching relay 221 and a directional coupler 225 for maintaining a non-interruptible communication port 260. As illustrated, amplifier 200 can support a plurality of bi-directional communication ports for sending and receiving RF signals to and from a variety of signal sources and destinations.

Similar to amplifier 100 previously discussed herein, amplifier 200 can provide a bi-directional RF input port 210 can be provided for receiving RF signals from a service provider, or any other appropriate signal source. Input port 210 can also pass output signals in the reverse direction from the amplifier 100 through the port 210 to the service provider or other signal source.

A plurality of bi-directional output ports 260, 262, and 266 can also be provided by amplifier 200 for passing RF signals from the amplifier 200 to one or more devices in communication with the output ports, and vice versa. Similar to amplifier 100, it will be appreciated that any appropriate device that may advantageously send and/or receive an RF signal may be placed in communication with one or more of the various output ports of amplifier 200. For example, it is contemplated that telephone, CATV, Internet, VoIP, and/or data communication devices may be placed in such communication where the amplifier 200 is installed in the residence of a subscriber to a service provider. However, it will further be appreciated that any desired combination of these and/or other devices may be used where appropriate, including devices other than those set forth in the labels of FIG. 2.

Signals received through input port 210 can be passed through a first communication path between input port 210 and output ports 260, 262, and/or 266. Specifically, the signals can be fed through a SPDT non-latching relay 221 to a high/low diplexer 230 for separating the high frequency input signal from any low frequency output signal incident in the reverse direction. In various embodiments, diplexer 230 can filter the signals in a manner such that signals with frequencies greater than approximately 45-50 MHz are passed as high frequency input signals received from port 210, while signals with frequencies lower than such range are passed in the reverse direction as low frequency output signals received from ports 260, 262, or 266.

The high frequency input signals filtered by diplexer 230 can be amplified by individual amplifier 240, and passed to high/low diplexer 235 where they are combined with the output signals. The recombined signal can then be provided to power dividers 250, where it is distributed to any of ports 260, 262, and/or 266.

Turning now to the reverse signal flow through the first communication path of amplifier 200, signals received by the amplifier 200 from devices in communication with ports 262 and/or 266 can be passed to power dividers 250 where they are combined into a composite output signal. Signals received through port 260 can be passed to power dividers 250 through passive directional coupler 225 and also combined into the composite signal. The output signal can be fed through high/low diplexer 235 for separating the low frequency output signal from any high frequency input signal incident in the forward direction. As previously discussed in relation to diplexer 230, the diplexer 235 can filter the signals such that signals with frequencies greater than approximately 45-50 MHz are passed in the forward direction as high frequency signals received from port 210, while signals with frequencies lower than such range are passed in the reverse direction as low frequency signals received from ports 260, 262, and/or 266.

The low frequency output signals filtered by diplexer 235 can be amplified by individual amplifier 245, and passed to high/low diplexer 230 where they are combined with the input signals. In various embodiments, individual amplifier 245 can optionally be omitted from amplifier 200. The recombined signal can then be provided to non-latching relay 221 where it is passed to port 210 for output to a service provider or other entity in communication with port 210.

As illustrated, amplifier 200 can further provide a power passing path 280, allowing power to be transmitted between ports 210 and 260.

During normal operation, the amplifier 200 can be powered from a power input port 270 and/or power that is reverse fed through RF Out N/VDC in port 266. In a typical installation at a subscriber's residence, it is contemplated that amplifier 200 may be powered by an AC/DC adapter receiving power provided by the residence (for example, 100-230 VAC, 50/60 Hz). As illustrated in FIG. 2, the power received from either power input can be provided to a voltage regulator 275 which supplies an operating voltage VCC to individual amplifiers 240 and/or 245.

In the event that power to voltage regulator 275 is interrupted, voltage regulator 275 will be unable to provide operating voltage VCC to individual amplifiers 240 and/or 245. As a result, individual amplifier 240 will not function to amplify the input signals received through port 210 for proper distribution to the various output ports 260, 262, and/or 266. Similarly, individual amplifier 245 also will not function to amplify the output signals received from ports 260, 262, and/or 266.

Accordingly, amplifier 200 further provides a second communication path between input port 210 and output port 260. In this regard, a dedicated non-interruptible port 260 can communicate with port 210 through relay 221 and coupler 225. As illustrated, amplifier 200 provides a VCC path 223 to relay 221. When power (i.e. VCC) is interrupted, the relay 221 will be caused to switch from the normal signal path in the “set” position, to the non-interruptible signal path in the “reset” position or vice versa. As a result, using the non-interruptible signal path between ports 210 and 260 through relay 221 and coupler 225, signals can still be passed between a device in communication with port 260 and a service provider in communication with port 210. It will be appreciated that although the second communication path of amplifier 200 does not necessarily amplify the input or output signals, the path can nevertheless permit communication of at least one or more services, such as emergency 911 telephone service.

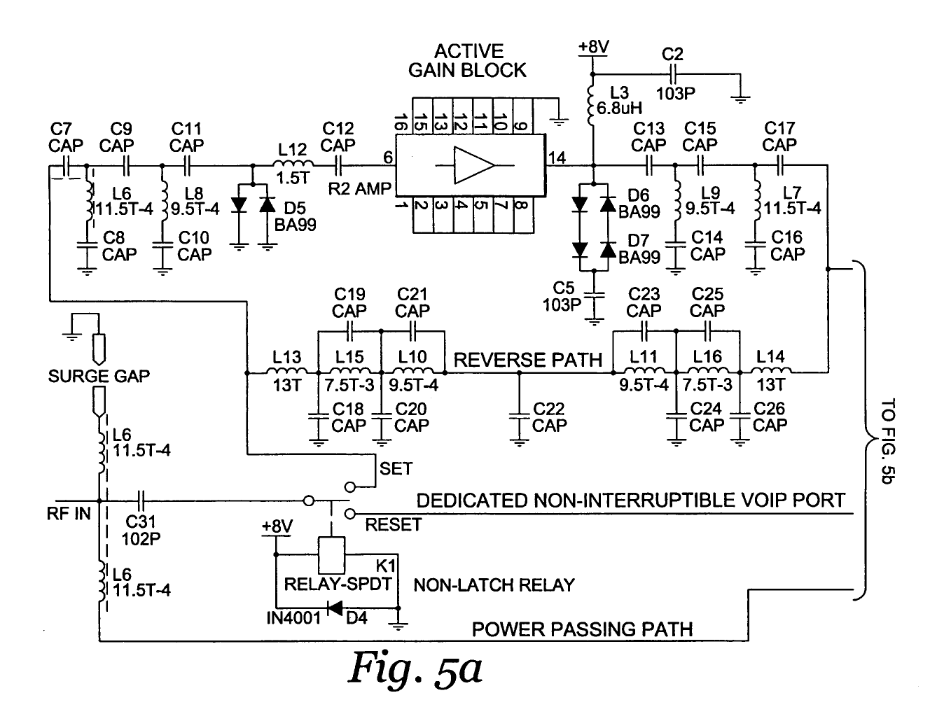

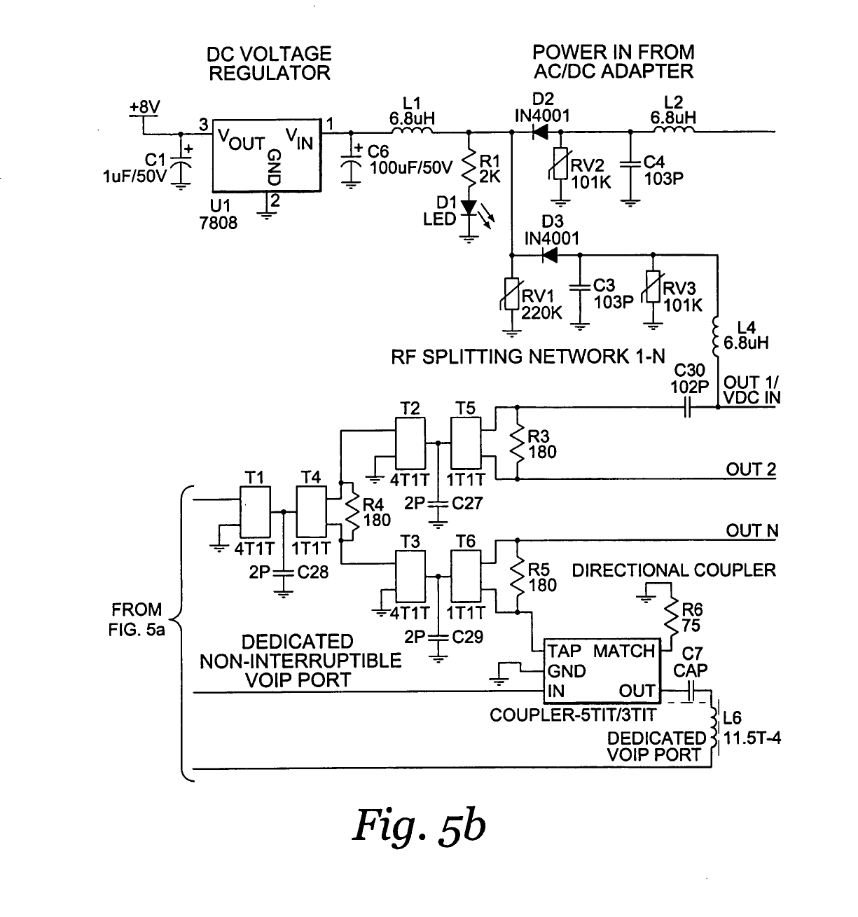

It will be appreciated that the use of the second communication path between ports 210 and 260 can provide a significant advantage in ensuring the availability of communication to at least one communication device in the event of power failure. A communication device in communication with port 260 (such as a VoIP compatible device, or other device) can further be provided with backup battery power to maintain the operation of the communication device. As discussed, a schematic representation of the amplifier 200 of FIG. 2 is set forth in FIGS. 5a and 5b.

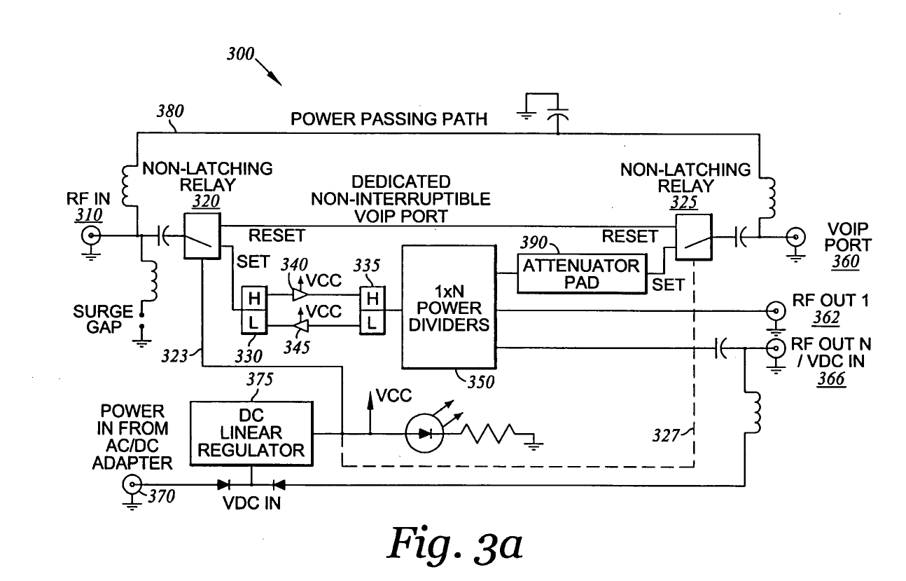

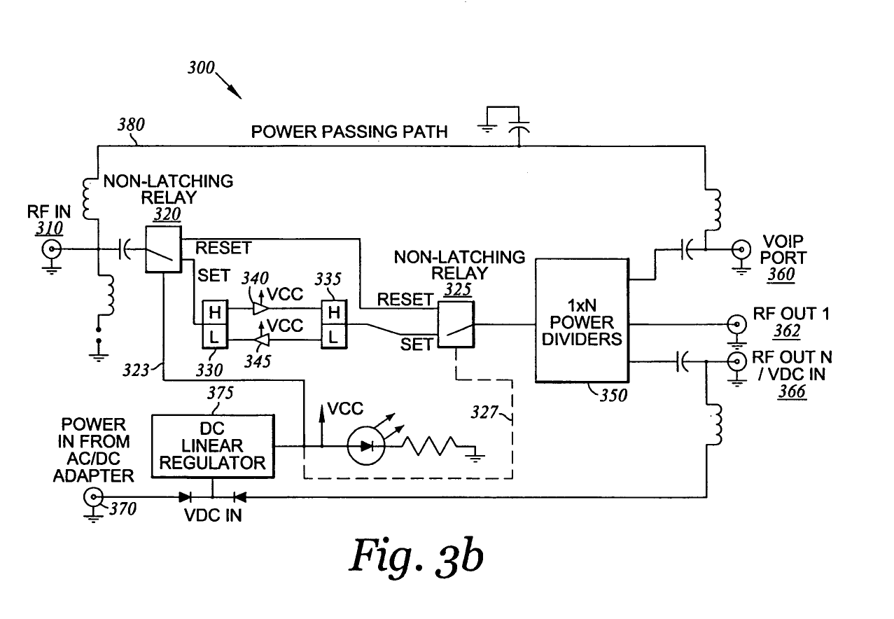

FIG. 3a illustrates a block diagram of a bi-directional RF signal amplifier 300 employing a plurality of non-latching relays for facilitating a non-interruptible communication port 360. As illustrated, amplifier 300 can support a plurality of bi-directional communication ports for sending and receiving RF signals to and from a variety of signal sources and destinations.

Similar to amplifiers 100 and 200 previously discussed herein, amplifier 300 can provide a bi-directional RF input port 310 can be provided for receiving RF signals from a service provider, or any other appropriate signal source. Input port 310 can also pass output signals in the reverse direction from the amplifier 300 through the port 310 to the service provider or other signal source.

A plurality of bi-directional output ports 360, 362, and 366 can also be provided by amplifier 300 for passing RF signals from the amplifier 300 to one or more devices in communication with the output ports, and vice versa. Similar to amplifiers 100 and 200, it will be appreciated that any appropriate device that may advantageously send and/or receive an RF signal may be placed in communication with one or more of the various output ports of amplifier 300. For example, it is contemplated that telephone, CATV, Internet, VoIP, and/or data communication devices may be placed in such communication where the amplifier 300 is installed in the residence of a subscriber to a service provider. However, it will further be appreciated that any desired combination of these and/or other devices may be used where appropriate, including devices other than those set forth in the labels of FIG. 3.

Signals received through input port 310 can be passed through a first communication path between input port 310 to output ports 360, 362, and/or 366. Specifically, the signals can be fed through a non-latching relay 320 to a high/low diplexer 330 for separating the high frequency input signal from any low frequency output signal incident in the reverse direction. In various embodiments, diplexer 330 can filter the signals in a manner such that signals with frequencies greater than approximately 45-50 MHz are passed as high frequency input signals received from port 310, while signals with frequencies lower than such range are passed in the reverse direction as low frequency output signals received from ports 360, 362, or 366.

The high frequency input signals filtered by diplexer 330 can be amplified by individual amplifier 340, and passed to high/low diplexer 335 where they are combined with the output signals. The recombined signal can then be provided to power dividers 350, where it is distributed to any of ports 360, 362, and/or 366. As illustrated, signals provided to port 360 through a SPDT non-latching relay 325 can further be passed through an attenuator pad 390 for reducing the strength of the amplified signal (approximately 20 dBmV/channel) by approximately 5 dBmV/channel.

Turning now to the reverse signal flow through the first communication path of amplifier 300, signals received by the amplifier 300 from devices in communication with ports 362 and/or 366 can be passed to power dividers 350 where they are combined into a composite output signal. Signals received through port 360 can be passed to power dividers 350 through non-latching relay 325 and attenuator pad 390, and also combined into the composite signal. The output signal can be fed through high/low diplexer 335 for separating the low frequency output signal from any high frequency input signal incident in the forward direction. As previously discussed in relation to diplexer 330, the diplexer 335 can filter the signals such that signals with frequencies greater than approximately 45-50 MHz are passed in the forward direction as high frequency signals received from port 310, while signals with frequencies lower than such range are passed in the reverse direction as low frequency signals received from ports 360, 362, and/or 366.

The low frequency output signals filtered by diplexer 335 can be amplified by individual amplifier 345, and passed to high/low diplexer 330 where they are combined with the input signals. In various embodiments, individual amplifier 345 can optionally be omitted from amplifier 300. The recombined signal can then be provided to SPDT non-latching relay 320 where it is passed to port 310 for output to a service provider or other entity in communication with port 310.

As illustrated, amplifier 300 can further provide a power passing path 380, allowing power to be transmitted between ports 310 and 360.

During normal operation, the amplifier 300 can be powered from a power input port 370 and/or power that is reverse fed through RF Out N/VDC in port 366. In a typical installation at a subscriber's residence, it is contemplated that amplifier 300 may be powered by an AC/DC adapter receiving power provided by the residence (for example, 100-230 VAC, 50/60 Hz). As illustrated in FIG. 3, the power received from either power input can be provided to a voltage regulator 375 which supplies an operating voltage VCC to individual amplifiers 340 and/or 345.

In the event that power to voltage regulator 375 is interrupted, voltage regulator 375 will be unable to provide operating voltage VCC to individual amplifiers 340 and/or 345. As a result, individual amplifier 340 will not function to amplify the input signals received through port 310 for proper distribution to the various output ports 360, 362, and/or 366. Similarly, individual amplifier 345 also will not function to amplify the output signals received from ports 360, 362, and/or 366.

As a result, amplifier 300 further provides a second communication path between input port 310 and output port 360. In this regard, a dedicated non-interruptible port 360 can communicate with port 310 through relay 320 and relay 325. As illustrated, amplifier 300 provides a VCC path 323 to relay 320, and a second VCC path 327 to relay 325. When power (i.e. VCC) is interrupted, the relays 320 and 325 will be caused to switch from the normal signal path in the “set” positions, to the non-interruptible signal path in the “reset” positions or vice versa. As a result, using the non-interruptible signal path between ports 310 and 360 through relays 320 and 325, signals can still be passed between a device in communication with port 360 and a service provider in communication with port 310. It will be appreciated that although the second communication path of amplifier 300 does not necessarily amplify the input or output signals, the path can nevertheless permit communication of at least one or more services, such as emergency 911 telephone service.

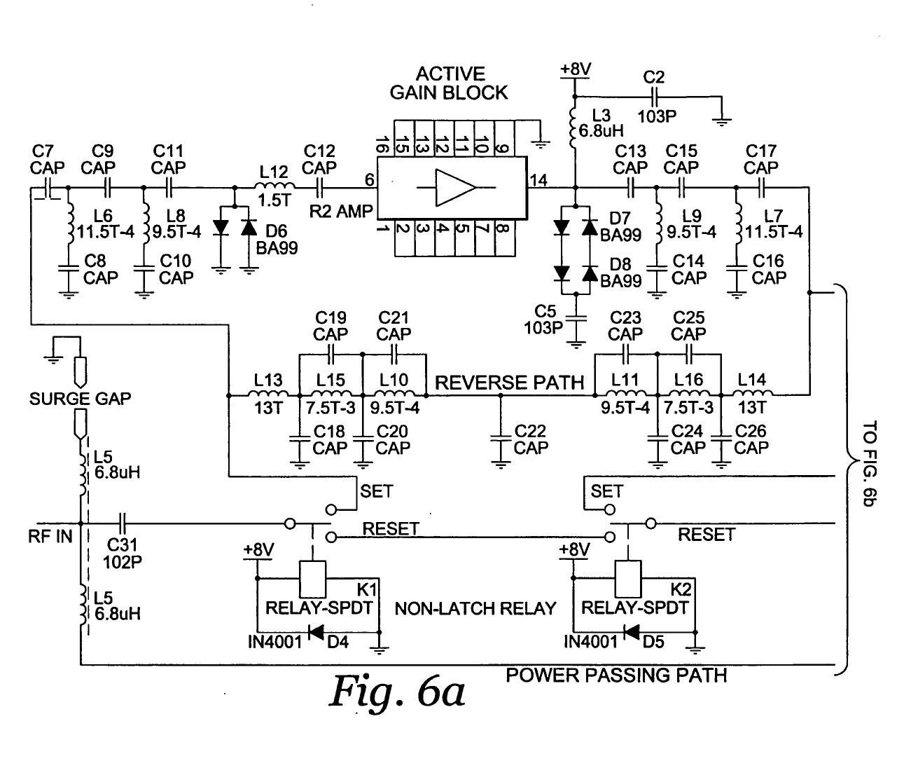

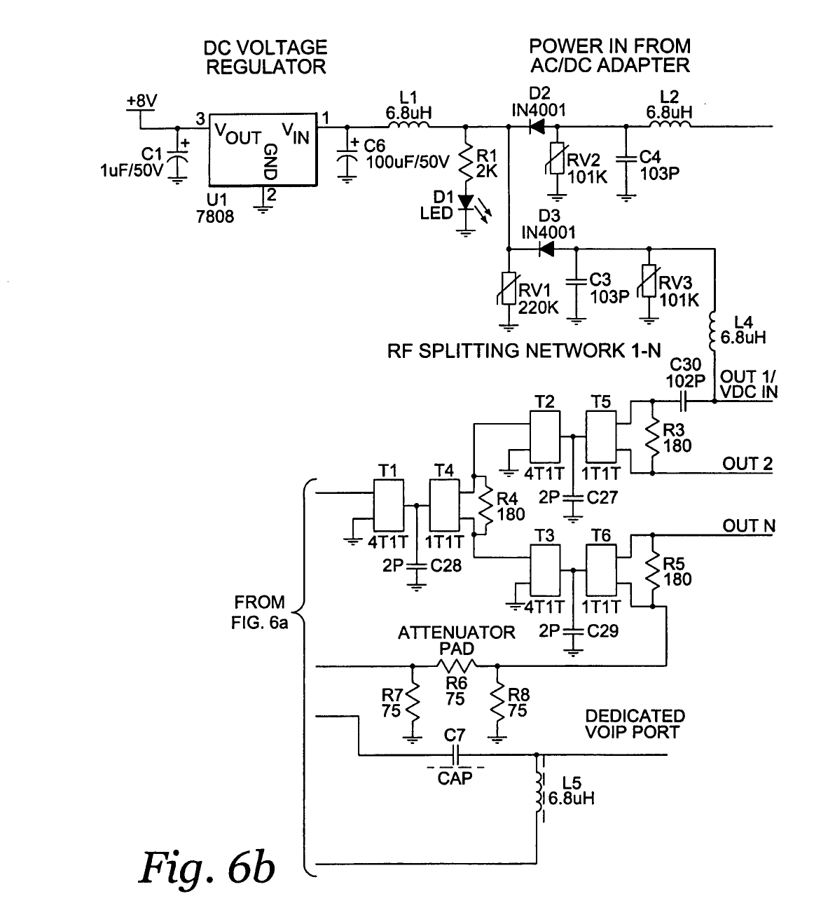

It will be appreciated that the use of the second communication path between ports 310 and 360 can provide a significant advantage in ensuring the availability of communication to at least one communication device in the event of power failure. A communication device in communication with port 360 (such as a VoIP compatible device, or other device) can further be provided with backup battery power to maintain the operation of the communication device. As discussed, a schematic representation of the amplifier 300 of FIG. 3a is set forth in FIGS. 6a and 6b.

FIG. 3b illustrates a block diagram of an alternate embodiment of bi-directional RF signal amplifier 300. As illustrated, the embodiment of FIG. 3b revises the connections of relay 325, diplexers 335, and power dividers 350. It will be appreciated that the embodiment of FIG. 3b allows each of the output ports 360, 362, and 366 to be switched. It will further be appreciated that a schematic representation of the embodiment of FIG. 3b can be provided through appropriate manipulation of the schematic of FIGS. 6a and 6b.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. For example, any number of RF output ports may be supported by the various amplifier embodiments discussed herein.

What is claimed is:

1. A bi-directional RF signal amplifier for providing non-interruptible RF signal communication between an RF input port and an RF output port, the amplifier comprising:
an RF input port;
an RF output port;
a power input for receiving electrical power;
circuitry for providing electrical power received by the power input to a plurality of amplifiers and a plurality of relays;
a first relay in communication with the input port, the first relay configured to switch from a powered position to an un-powered position when electrical power provided to the first relay is interrupted;
a second relay in communication with the output port, the second relay configured to switch from a powered position to an un-powered position when electrical power provided to the second relay is interrupted;
a first communication path for providing communication between the input port and the output port when electrical power is received at the power input, the first communication path comprising:
the first relay switched in the powered position,
the second relay switched in the powered position, and
a forward path amplifier in communication with the first relay and second relay; and
a second communication path for providing communication between the input port and the output port when electrical power to the power input is interrupted, the second communication path comprising:
the first relay switched in the un-powered position, and
the second relay switched in the un-powered position.

2. The bi-directional RF signal amplifier of claim 1, further comprising:
a reverse path amplifier in communication with the first relay and second relay.

3. The bi-directional RF signal amplifier of claim 1, further comprising:
a first diplexer in communication with the first relay and the forward path amplifier;
a second diplexer in communication with the forward path amplifier;
a plurality of power dividers in communication with the second diplexer, at least one of the power dividers in communication with the second relay; and
a plurality of output ports in communication with the power dividers.

4. The bi-directional RF signal amplifier of claim 3, further comprising:
an attenuator pad in series between at least one of the power dividers and the second relay.

5. The bi-directional RF signal amplifier of claim 3, the power input is one of the output ports.

6. The bi-directional RF signal amplifier of claim 1, the power input is adapted to receive electrical power from an AD/DC adapter.

7. The bi-directional RF signal amplifier of claim 1, further comprising:
a power passing path between the input port and the output port.

8. The bi-directional RF signal amplifier of claim 1, the RF signal is a signal selected from the group consisting of:
a telephone signal;
a CATV signal;
an Internet signal;
a VoIP signal; and
a data communication signal.

9. The bi-directional RF signal amplifier of claim 1, further comprising:
a first diplexer in communication with the first relay and the forward path amplifier;
a second diplexer in communication with the forward path amplifier and the second relay;
a plurality of power dividers in communication with the second relay; and
a plurality of output ports in communication with the power dividers.

10. A bi-directional RF signal amplifier for providing non-interruptible RF signal communication between an RF input port and an RF output port, the amplifier comprising:
an RF input port;
an RF output port;
a power input for receiving electrical power;
circuitry for providing electrical power received by the power input to a plurality of amplifiers and a relay;
the relay in communication with the input port, the relay configured to switch from a powered position to an un-powered position when electrical power provided to the relay is interrupted;
a directional coupler in communication with the output port;
a first communication path for providing communication between the input port and the output port when electrical power is received at the power input, the first communication path comprising:
the relay switched in the powered position,
the directional coupler, and
a forward path amplifier in communication with the relay and the directional coupler; and
a second communication path for providing communication between the input port and the output port when electrical power to the power input is interrupted, the second communication path comprising:
the relay switched in the un-powered position, and
the directional coupler.

11. The bi-directional RF signal amplifier of claim 10, further comprising:
a reverse path amplifier in communication with the relay and the directional coupler.

12. The bi-directional RF signal amplifier of claim 10, further comprising:
a first diplexer in communication with the relay and the forward path amplifier;
a second diplexer in communication with the forward path amplifier;
a plurality of power dividers in communication with the second diplexer, at least one of the power dividers in communication with the directional coupler; and
a plurality of output ports in communication with the power dividers.

13. The bi-directional RF signal amplifier of claim 12, the power input is one of the output ports.

14. The bi-directional RF signal amplifier of claim 10, the power input is adapted to receive electrical power from an AD/DC adapter.

15. The bi-directional RF signal amplifier of claim 10, further comprising:
a power passing path between the input port and the output port.

16. The bi-directional RF signal amplifier of claim 10, the RF signal is a signal selected from the group consisting of:
a telephone signal;
a CATV signal;
an Internet signal;
a VoIP signal; and
a data communication signal.

17. A bi-directional RF signal amplifier for providing non-interruptible RF signal communication between an RF input port and an RF output port, the amplifier comprising:
an RF input port;
a first RF output port;
a second RF output port;
a power input for receiving electrical power;
circuitry for providing electrical power received by the power input to a plurality of amplifiers;
a directional coupler in communication with the input port;
a first communication path for providing communication between the input port and the first output port when electrical power is received at the power input, the first communication path comprising:
the directional coupler, and
a forward path amplifier in communication with the directional coupler; and
a second communication path for providing communication between the input port and the second output port when electrical power to the power input is interrupted, the second communication path comprising the directional coupler in communication with the second output port.

18. The bi-directional RF signal amplifier of claim 17, further comprising:
a reverse path amplifier in communication with the directional coupler.

19. The bi-directional RF signal amplifier of claim 17, further comprising:
a first diplexer in communication with the directional coupler and the forward path amplifier;
a second diplexer in communication with the forward path amplifier;
a plurality of power dividers in communication with the second diplexer; and
a plurality of output ports in communication with the power dividers, at least one of the plurality of output ports is the first output port.

20. The bi-directional RF signal amplifier of claim 19, the power input is one of the output ports.

21. The bi-directional RF signal amplifier of claim 17, the power input is adapted to receive electrical power from an AD/DC adapter.

22. The bi-directional RF signal amplifier of claim 17, further comprising:
a power passing path between the input port and the output port.

23. The bi-directional RF signal amplifier of claim 17, the RF signal is a signal selected from the group consisting of:
a telephone signal;
a CATV signal;
an Internet signal;
a VoIP signal; and
a data communication signal.
